(19) United States
(12) Patent Application Publication
(10) Pub. No.: US 2017/0103617 A1
(43) Pub. Date: Apr. 13, 2017

(54) Method and System for Playing the Game of Chess

(71) Applicant: Eyal Navon, San Francisco, CA (US)

(72) Inventor: Eyal Navon, San Francisco, CA (US)

(21) Appl. No.: 14/882,332

(22) Filed: Oct. 13, 2015

(51) Int. Cl. G07F 17/32; A63F 3/02

(52) U.S. Cl. CPC G07F 17/3295; A63F 3/02

(57) ABSTRACT

A computer-implemented method for playing chess between first and second player each of whom in turn moves a selected chess piece across a chess board in conformity with predefined rules and each having a respective display device. Information relating to a current state of the board is relayed to each respective display device, each player making alternate moves and receiving information representative of a resulting chess board wherein an identity and source location of a piece moved by either one of the players is revealed to a respective opponent but a destination location of the moved piece is not explicitly relayed to the opponent until immediately after the opponent makes a move. At any stage during play an attempted illegal move that does not conform to the predefined rules is ignored while notifying the player who made the illegal move and prompting him to make a different move.

### FIELD OF THE INVENTION

This invention relates to the game of chess and particularly to a version of chess playable by two players using respective play stations or computers.

### BACKGROUND OF THE INVENTION

The game of chess needs no introduction. Although traditionally it is played using a board and chess pieces, there are also computer-assisted versions of the game where either two players sitting at respective computer terminals play opposite each other, typically remote, or where one player pits his skill against the computer.

In the following description we shall utilize conventional chess nomenclature for identifying the board and moves of different chess pieces. Thus, with reference to FIG. 1 showing the initial board layout, the following nomenclature is as follows:

R for a rook

N for a knight

B for a bishop

K for a king

Q for a queen

no letter for a pawn

Each square on the chess board is given by a coordinate, much like a map. The rows (in chess language, ranks) are labeled with Arabic numerals (i.e., 1, 2, 3 . . . ), and the columns (in chess language, files) are labeled with letters of the English alphabet (i.e., a, b, c . . . ). A square's coordinate is first its column followed by its row. For example, in the board shown in FIG. 1, black's king is on the square d5.

If black moves his king to, say, d6, the move is notated as Kd6, i.e. the king has moved to square d6.

Although the conventional nomenclature also accommodates more complex scenarios, the following description of the invention will be confined to simple moves for which the above summary is sufficient.

U.S. Pat. No. 6,203,016 discloses a method of playing chess in which eventually all chess moves are played out on a chess board in full view, but some of these moves are previously recorded out-of-view. This incorporates chess moves in the play of the chess game that at the time decided upon are not known as to their effect on the outcome of the game, such that an element of chance, i.e., whether the moves are or are not effective in removing the opponent's chess pieces from play, is a factor in the to play which significantly contributes to the play value of the chess game. This can lead to coincidence of double occupancy of a playing surface square, in which case one of the conflicting pieces is removed.

It is apparent from the description in this patent that two players make regular moves that each can see and concealed moves out of sight of their respective opponents. But each player makes two successive moves, which means that they do not make alternate moves as is the case with the rules of conventional turn-based chess. This being said, the first of the two moves is to reveal a previously concealed move and is then followed by the current move, which is concealed to the opponent. Obviously, the fact that the player himself reveals his previously concealed move is a potential source of abuse. Furthermore, this reference conceals both the identity of the piece being moved as well as its destination and consequently introduces a higher element of randomness or luck into the game, which of course is not inherent in traditional chess. Without derogating from the fun of such a game, the randomness is inconsistent with the strategic skills that characterize traditional chess.

U.S. Pat. No. 5,957,455 discloses a method of playing chess that combines the strategic skills of traditional chess with memory skills and allows the initial placement of the chess pieces to be varied. To this end, the game pieces are constructed so that a player can view his own game pieces from one side, but the player's opponent is unable to determine the identity of those game pieces from the other side. By such mean, a player's moves may be concealed from his opponent after initial placement and even from the player himself. This tests the players' memories since they must memorize the game state immediately after a move is made.

Kriegspiel is a chess variant sometimes referred to as blind chess wherein each player can see their own pieces, but not those of their opponent. A third person or computer acts as a referee, with full information about the progress of the game. When it is a player's turn he or she will attempt a move, which the referee will declare to be ‘legal’ or ‘illegal’. If the move is illegal, the player tries again; if it is legal, that move stands. Each player is given information about checks and captures. They may also ask the referee if there are any legal captures with a pawn. Since the position of the opponent's pieces is unknown, Kriegspiel is not a game with perfect information.

U.S. Pat. No. 7,410,418 discloses a chess-like game wherein only information relating to specific squares is provided to a player. The information excludes positions and types of game pieces on any other squares and the game may also involve non-alternating moves.

### SUMMARY OF THE INVENTION

It is an object of the invention to add an element of calculated surprise and risk management to the game of chess but without imposing new movement rules on the game or changing existing rules.

According to one aspect of the invention there is provided a computer-implemented method for playing a game of chess between a first player and a second opposing player each of whom in turn moves a respective selected chess piece across a chess board in conformity with predefined chess rules and each of whom has a respective display device, the method including iteratively:

relaying information relating to a current state of the chess board to the respective display device of each player;

allowing each player to make alternate moves and conveying to each player information representative of a resulting chess board wherein an identity and source location of a piece moved by either one of the players is revealed to a respective opponent but a destination location of the moved piece is not explicitly relayed to the opponent until immediately after the opponent makes a move so that for successive moves after the game commences the chess board displays to the player making the move an incomplete current state of play; and

if at any stage during play an illegal move is attempted that does not conform to the predefined rules, ignoring the illegal move while notifying the player who made the illegal move and prompting the player to make a different move.

The game is capable of being played manually between two players across a physical board. However, in this case in order to conceal each move from the opponent a mediator is then required to whom the desired move can be communicated without revealing it to the opponent. In either case, it is a feature of the invention that any move possible in chess is supported and vice versa. This appears not to be the case in some of the prior art variations discussed above.

More typically, the method is carried out via one or more computers with which the two players are able to communicate. Most typically, each player accesses a respective computer and successive moves made by each player are displayed on the player's computer screen but are not displayed on the opponent's computer screen until after he or she makes his next move. In this case, information defining each player's move is typically communicated to the opponent's computer but is simply not displayed so that the current player's computer can verify the validity of the move according to the rules of conventional chess. Alternatively, both players may play the game in communication with a central computer that performs the necessary housekeeping so as to ensure that any given instant, the immediately preceding move is concealed to the current player.

If at any stage during play an attempt to move is illegal according to the chess variation of the embodiment, the player who made the illegal move attempt is notified of it and requested to move again. This failed attempt to move may be concealed or not from the other player depending on the particular embodiment. The process of attempting illegal moves can repeat itself until the move attempt is legal. A common example of cases like that can be when trying to move the pawns in diagonal in order to capture while it is unclear if the destination square is empty or not.

The chess rules are predefined and typically conform to conventional chess rules. However, the invention is applicable to variations of the game that allow each player to move alternately albeit according to different rules. The invention is thus not restricted to any specific rules of chess provided only that the rules are predefined and known to both players and to the mediator, whether the mediator be a person or a computer.

Although the invention shares features that are known per se, the combination of known features and the further provision of features not previously proposed results in a game where chess software and chess knowledge will be less significant while retaining the entire set of “movement rules” intact. Furthermore, the invention allows new manipulations to be employed that can be foreseen and assessed ahead of time by both players. For example, a first player can anticipate that a certain concealed move will be made by his opponent and will make his move, so as knowingly to avoid ahead of time a specific move by his opponent that would lead to a bad scenario for the first player. In this sense it is different than Kriegspiel, where the opening of a game is made under complete darkness and also many subsequent turns are made with little to no additional knowledge of the opponent's moves. Analyzing a state of the game according to the present invention requires drilling down into a wider tree of decisions compared to conventional chess (i.e. looking into more options per turn) due to the game theory concept of mixed strategies the lack of knowledge as opposed to pure strategy and perfect information upon which conventional chess is based. This empowers positional playing and adds calculated risk management.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a pictorial representation of a conventional chess board prior to start of play showing row and column nomenclature;

FIGS. 2 to 12 are pictorial representations of the chess board after successive moves of the game according to the method of the invention; and

FIG. 13 is a schematic diagram of a system hosting the game over the Internet.

### DETAILED DESCRIPTION OF EMBODIMENTS

An embodiment of this embodiment reduced to practice used colors to identify the source location of selected pieces and the description will make reference to these colors, without limitation. For readers who see the drawings in grey scale, the borders have been provided with reference numerals and these, too, will be referenced in the following description.

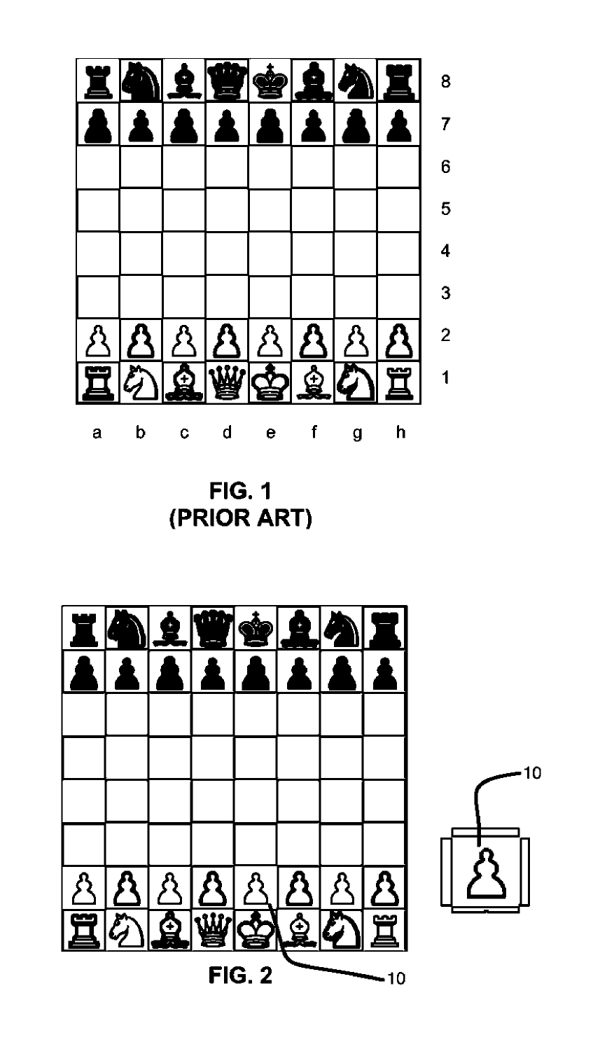

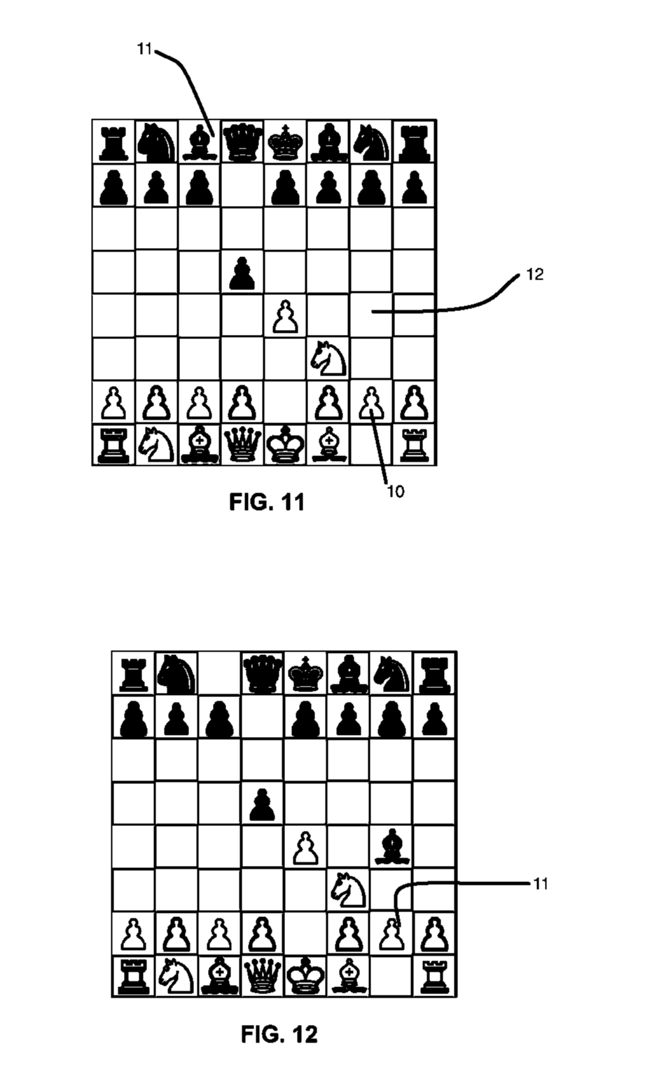

FIGS. 2 to 12 show the instantaneous state of the board during successive moves of the game when implemented by a computer and displayed to each player on a respective screen. Thus, in FIG. 2 the game commences and it is White's turn to play. White selects the pawn on square e2 for movement. In a computer implemented version of the game, this is displayed to White by changing the color of the border of the square e2 from an initial default color to a new color 10 (shown as yellow in the figures). We will refer to the new color as the ‘select’ color since it identifies a piece as having been to selected for play prior to its being actually moved. However, it is not displayed to Black, so that Black does not know which piece has been selected by White for play. The selected piece with the yellow border is also shown in enlarged detail alongside the board in FIG. 2. Obviously any other display attribute of the square may be changed to denote the square of the selected piece. For example, the border may be emboldened or shaded or it may be displayed intermittently as a flashing border or the complete border can be shaded, displayed intermittently and so on. In the following description we will refer to colors because in a practical embodiment reduced to practice and available on-line colors were used.

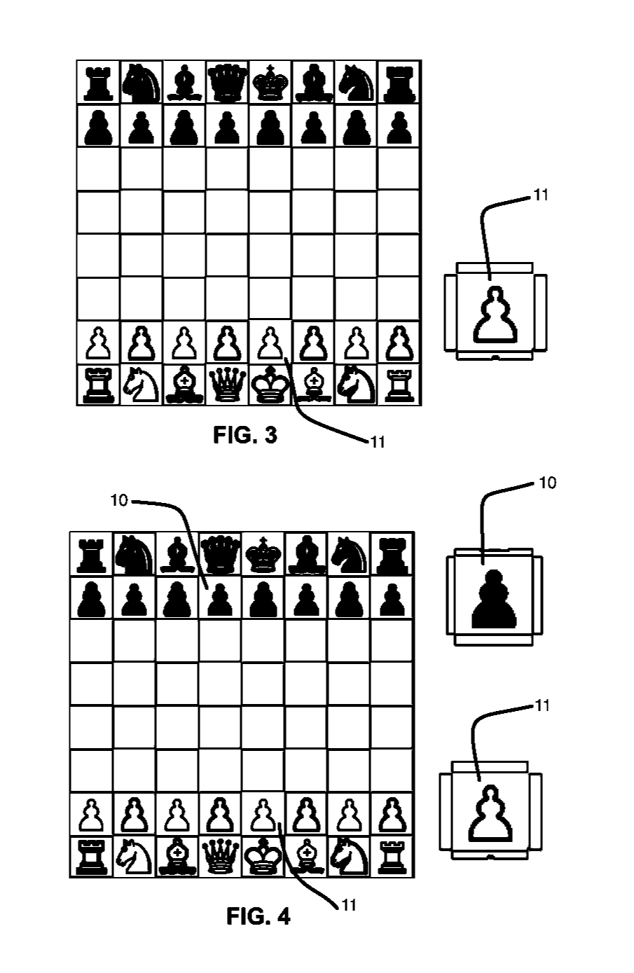

In FIG. 3, White moves the selected pawn to square e4. This move is displayed to White since it is his move but it is concealed from Black. In a computer implemented version of the game, this may optionally be displayed to White by changing the color of the border of the square e2 from the ‘select’ color 10 (yellow) to a new color 11 (shown as pink in the figures). We will refer to the new color as the ‘move’ color since it identifies a selected piece as having now been moved. The moved piece with the pink border is also shown in enlarged detail alongside the board in FIG. 3. It should be understood that the figures obviously represent an instantaneous snapshot of the board. Once the pawn is moved to e4, the border of e4 as displayed to White may be changed to the ‘move’ color.

In an alternative embodiment of the invention, the border of e2 may also be displayed in the ‘move’ color 11 to Black so that in this version of the game, each player knows which piece was last moved by the opponent but does not know to where it was moved. Obviously to skilled players this option may result in a trivial result since there may, in fact, be only one actual or at least feasible move for the selected piece. But we cover this option partly for the sake of complete disclosure and also since it may be of greater application to less skilled players and may even be a useful as a teaching aid. Furthermore, when combined with the monitoring of illegal moves, this provides a surprising advantage over hitherto-proposed approaches as noted above.

It is now Black's turn to move. In FIG. 3 Black selects the pawn on d7 for movement. In a computer implemented version of the game, this is displayed to Black by changing the color of the border of the d7 from the initial default color to the select color 10 (yellow). If the colored border is not displayed to White, White does not know which piece is selected by Black for play. But regardless of whether or not it is shown, to its destination is concealed from White. The selected piece with the yellow border is also shown in enlarged detail alongside the board in FIG. 3.

In FIG. 4, Black moves the selected pawn to d5. This move is concealed from White but is displayed to Black since it is his move by changing the color of the border of d5 from the selected color 10 (yellow) to the move color 11 (pink). The moved piece with the pink border is also shown in enlarged detail alongside the board in FIG. 4.

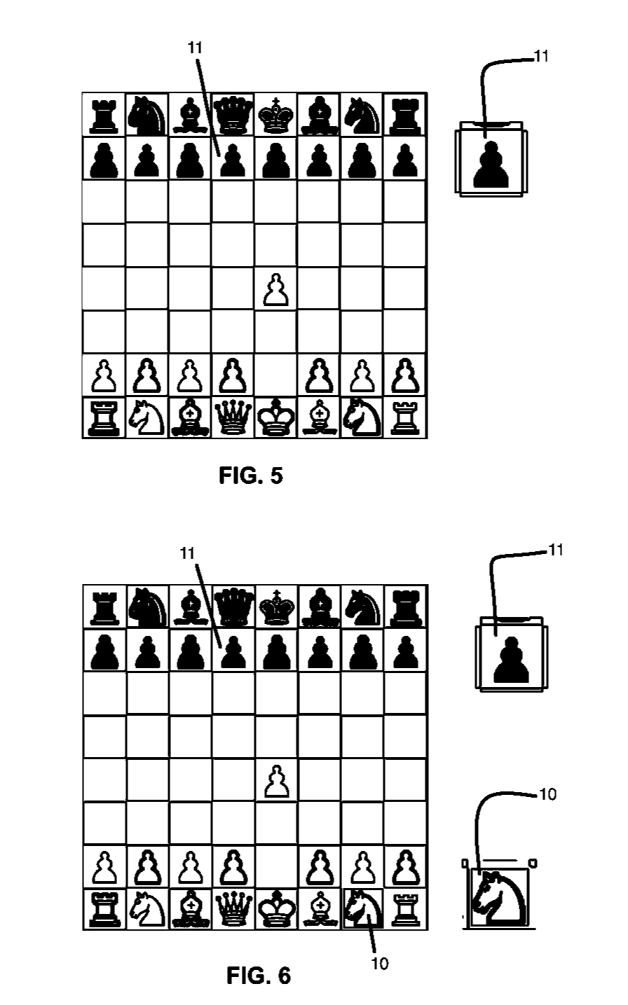

Referring to FIG. 5 it is seen that once Black completes his move, the preceding move e2-e4 made by White is now displayed. Thus the moved pawn in e4 is now displayed to both players using the default border.

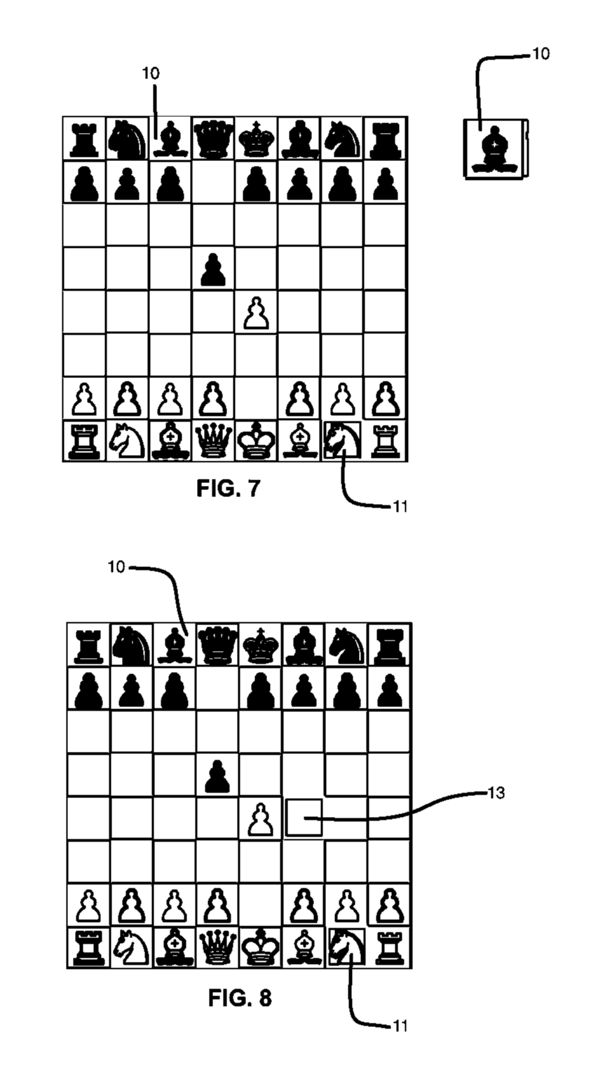

It is now White's turn to move. In FIG. 6 White selects the knight on e1 for movement. In a computer implemented version of the game, this is displayed to White by changing the color of the border of e1 from the default color to the select color 10 (yellow). However, it is not displayed to Black, so that Black does not know which piece is selected by White for play. The selected piece with the yellow border is also shown in enlarged detail alongside the board in FIG. 6. White moves the selected knight to f3. This move is displayed to White since it is his move but it is concealed from Black. In a computer implemented version of the game, this is displayed to White by changing the color of the border of the f3 from the select color 10 (yellow) to the move color 11 (pink). The moved piece with the pink border is also shown in enlarged detail alongside the board in FIG. 7.

It is now Black's turn to move. In FIG. 7 Black selects the bishop on c8 for movement. In a computer implemented version of the game, this is displayed to Black by changing the color of the border of c8 from the initial default color to the select color 10 (yellow). However, the colored border is not displayed to White, so that White does not know which piece is selected by Black for play. The selected piece with the yellow border is also shown in enlarged detail alongside the board in FIG. 7. Black moves the selected bishop to f4. It is seen that this is an invalid move since c8 where the selected bishop is located is white and therefore the selected bishop is constrained to move along white diagonals only. But typically in a computer implemented version of the game, a piece is selected using a pointing device such as a mouse, and invalid moves can easily be made by inadvertently clicking on the wrong square. The computer identifies to Black that the move is invalid by changing the color of the border of f4 from the initial default color to a new color 12 (shown as red in the figures). We will refer to the new to color red as the ‘invalid’ color since it identifies a piece as having been moved invalidly.

In FIG. 8, Black moves the selected bishop correctly to g4. This move is concealed from White but is displayed to Black by changing the color of the borders of both c8 and g4 from the selected color 10 (yellow) to the move color (pink). The moved piece with the pink border 11 is also shown in enlarged detail alongside the board in FIG. 7.

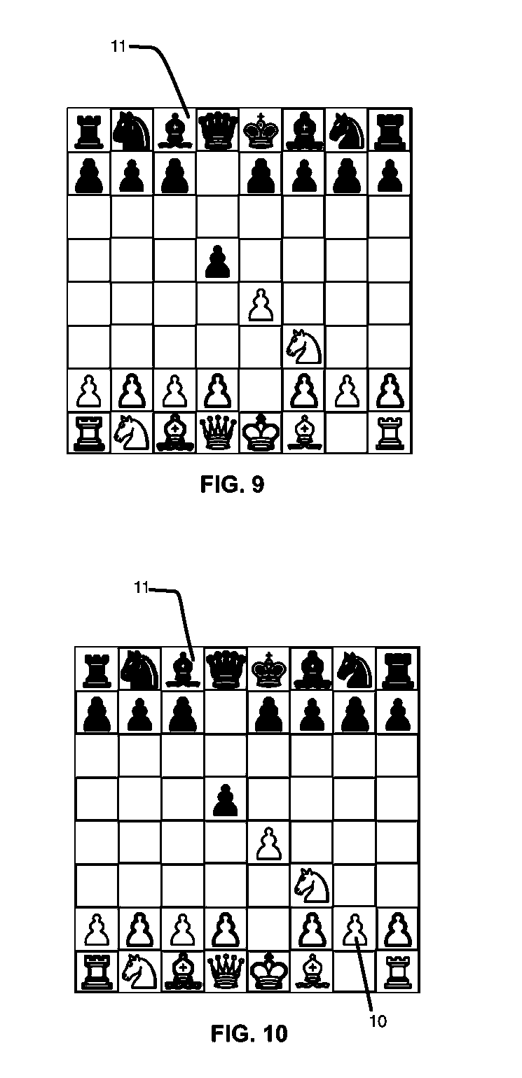

Referring to FIG. 9 it is seen that once Black completes his move, the preceding move of White's knight from e1-f3 is now displayed. Thus the moved knight in f3 is now displayed to both players using the default border.

It is now White's turn to move. In FIG. 10 White selects the pawn on g2 for movement. In a computer implemented version of the game, this is displayed to White by changing the color of the border of g2 from the default color to the select color 10 (yellow). However, it is not displayed to Black, so that Black does not know which piece is selected by White for play. White attempts to move the selected pawn to g4, which appears to White to be vacant and therefore valid. However, g4 is in fact already occupied by Black's bishop from the previous move and the proposed move is therefore invalid. Accordingly, the color of g4 is changed to red, i.e. the ‘invalid’ color 12, which indicates that White cannot move his pawn to g4. This, of course, creates a new layer of skills to the game since White knows that prima facie the move is valid and can therefore infer that g4 is occupied.

However, since the only piece on the board that is occupied but not yet displayed to White is Black's previous move, White now knows that Black moved his piece to g4. We have already suggested that in a simplified version of the game the identity of the last piece moved may be highlighted even though its destination remains concealed to the opponent. However, even in the advanced version of the game where this is not done, identifying that a square is occupied by a hidden piece allows this critical information to be deduced. In many cases, a skilled player will be able to guess which piece was most likely moved by his opponent thus adding a new dimension of skill to the game.

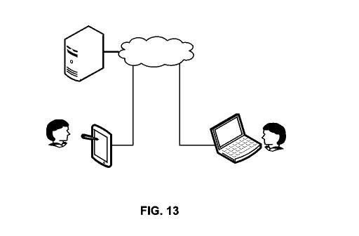

In this situation where a selected piece cannot be moved to the desired destination, there are two possibilities for further processing. The rules of chess typically require that ‘touch man moves’ which means that once a player has touched a to piece he is obligated to move that piece and no other. If this rule is enforced, White can only move the selected pawn to g2 as shown in FIG. 12, where the move is concealed from Black but displayed to White by changing the color of the border of the g2 from the select color 10 (yellow) to the move color 11 (pink).

However, in accordance with another embodiment of the invention, the rules may be relaxed so that when a selected piece cannot be moved to the desired destination because it is occupied by the opponent's previous move, the current player is allowed to select another piece for the current move.

The invention also embraces additional variations for the game which differ in the information (or lack of information) that an opponent will obtain after a piece is moved.

The information will consist a subset of the pieces (could be all or none as well). Per piece it might contain a potential subset of possible destinations. It might also contain a subset of destinations without being linked to a particular piece. This information might be true or false according to either some random mechanism or to additional information that the moving player will add after his move. In case of a check the other player is either informed or not about it.

These variations include the following, some of which have already been mentioned:
Showing the opponent which piece was moved, but not its destination location. In case of castling, the king is shown as the piece being moved. The opponent is informed in case of being in a state of check.
Showing the opponent which piece was moved, and a few alternatives for the destination of the moved piece. In case of king rook (castling), it will show the king as the piece being moved.
Showing the opponent a set of pieces that were possibly the moved piece, and either showing or not its destination locations or possible destination locations. In case of king rook, it will show the king as the piece being moved.
Providing the option for a player to have a few times per game where he conceals his moves.
Adding a random mechanism that shows the correct or incorrect information about a subset of possible moves. The subset will either include or not the immediately preceding move according to the random mechanism.
After a player completes a move, he is informed about the previous move of his opponent. This is the default option as described above.
In case of a checkmate, both players are informed, and the game finishes like in traditional chess.
The game may or may not be constrained by time limits, like traditional chess time variations.

FIG. 13 is a schematic diagram of a system hosting the game over the Internet. Two players are shown, one using a touchscreen tablet and the other a laptop both connected over the Internet. A host computer connected to the Internet is optionally connected to respective computers of both the players. In one embodiment, the server acts as the mediator and responds to a set of rules that may be defined by the players or by an operator (such as a chess tournament operator) so as to set the level of difficulty in accordance the variations listed above. In this case, the host computer sends different display data to each of the players' computers so that each player sees the information that he is allowed to see.

In accordance with another version, particularly suitable for standalone applications, an applet is downloaded to the players' computers and determines what is displayed according to a variable display attribute of each square of the board. In this case, the display attributes of each square of the board may be different for each player in accordance with the preset rules. This embodiment allows two players in close proximity, for example in the same room, to play each via a PDA for example using short range communication such as Bluetooth™.

In either implementation the skill level may be set for both players either globally when the host computer is the mediator or via the players' computers. The skill level does not need to be the same for both players.

It will also be appreciated that while the ‘move color’ aids description and understanding, there may be applications where it is not implemented in practice since if the player knows what he moved and his opponent is not allowed to know either the identity of the moved piece or its destination, there is no need to color it. In some to embodiments, the ‘move color’ may simply be a virtual color that maintains a record which piece has been touched so as to ensure that its destination is valid and, in those implementations requiring ‘touch man moves’, preventing selection of another piece.

In the described embodiments, the chess board displays to the player making the next move a cumulative state of play apart from a current position of a chess piece that was moved in an immediately preceding move. However, other implementations may conceal more than a single preceding move. Thus in its more general definition, the game is characterized by the chess board displaying to the player making the next move an incomplete current state of play.

It will be appreciated that in the context of the invention the term ‘computer’ embraces any suitable device having a memory containing an instruction set, a processor coupled to the memory for operating in accordance with the instruction set, a communications interface and possibly also a user interface and a display device or means for coupling a user interface and/or a display device thereto. Such devices include PDAs, mobile smartphones, tablets, PCs and so on.

It should also be noted that while that concealing a move has been described with regard to rendering the move invisible to the opponent player, the invention also contemplates includes concealing partial information about the move. For example, the current placement of a selected piece may be shown without its origin, or there may be shown only an indication of check, and highlighting the king in the event of castling but without displaying the current placement.

Likewise, it should be noted that the invention allows a piece to be moved into a legal place in the real board even though in the board as seen by the players it is illegal. For example, a pawn can move in a diagonal step into an apparently vacant square on the board, which is not normally permitted, and thereby capture a piece that was moved there in a previous turn. Thus, from the perspective of a player, moving a pawn diagonally is illegal unless it is to capture a piece in the square that is diagonally adjacent to the pawn. But if the diagonally adjacent square is vacant, such a move is a priori illegal. If at any stage during play an illegal move is attempted i.e. a move that does not conform to the predefined chess rules, the illegal move is ignored and the player who made the illegal move is notified and prompted to make a different move. According to different embodiments, the attempted illegal move may or may not be concealed from the other player. This process will repeat itself until a valid move was taken.

Regardless of whether the illegal move is concealed from the opponent, this may be used strategically by the current player to test whether the diagonally adjacent square is occupied since if the move is accepted, it may be deduced in hindsight that it was occupied and the capture of the concealed piece will also reveal its identity. Conversely, if the move is rejected as illegal, it may be deduced in hindsight that the square was vacant.

For the sake of clarification it should also be noted that are other mainstream variations of chess (time based, chess960 and so on). The invention is not limited to any one variation and the claims are intended to encompass the method and system for implementing the invention in any turned-based chess variation.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A computer-implemented method for playing a game of chess between a first player and a second opposing player each of whom in turn moves a respective selected chess piece across a chess board in conformity with predefined chess rules and each of whom has a respective display device, the method including iteratively:
relaying information relating to a current state of the chess board to the respective display device of each player;
allowing each player to make alternate moves and conveying to each player information representative of a resulting chess board wherein an identity and source to location of a piece moved by either one of the players is revealed to a respective opponent but a destination location of the moved piece is not explicitly relayed to the opponent until immediately after the opponent makes a move so that for successive moves after the game commences the chess board displays to the player making the move an incomplete current state of play; and
if at any stage during play an illegal move is attempted that does not conform to the predefined rules, ignoring the illegal move while notifying the player who made the illegal move and prompting the player to make a different move.

2. The method according to claim 1, including changing a display attribute that is associated with a square of the chess board at which a selected piece is located and that is displayed to the player making the move so as to highlight the square of the selected piece.

3. The method according to claim 1, including changing a display attribute that is associated with a square of the chess board at which a selected piece is located and that is displayed to the opponent so as to highlight the square of the selected piece.

4. The method according to claim 1, wherein each player operates a respective computer each of which is configured to display a different respective board wherein the opponent's preceding move is concealed.

5. The method according to claim 1, wherein each player sees a respective display device and each display device is coupled to a common computer that is configured to display on each display device a different respective board wherein the opponent's preceding move is concealed.

6. A system for playing a game of chess between a first player and a second opposing player each of whom in turn moves a selected chess piece across a chess board in conformity with predefined chess rules, the system comprising:
a respective display device for relaying information relating to a current state of the chess board to the each player; and
a processor coupled to each of the display devices for processing alternate moves made by each player and conveying to each player information representative of a resulting chess board wherein an identity and source location of a piece moved by either one of the players is revealed to a respective opponent but a destination location of the moved piece is not explicitly relayed to the opponent until immediately after the opponent makes a move so that for successive moves after the game commences the chess board displays to the player making the move an incomplete current state of play;
the processor being responsive at any stage during play to an illegal move that is attempted and does not conform to the predefined rules, for ignoring the illegal move while notifying the player who made the illegal move and prompting the player to make a different move.

7. The system according to claim 6, wherein the chess board displayed to the player making the move is configured to change a display attribute that is associated with a square of the chess board at which a selected piece is located so as to highlight the square of the selected piece.

8. The system according to claim 6, wherein the chess board displayed to the opponent of the player making the move is configured to change a display attribute that is associated with a square of the chess board at which a selected piece is located so as to highlight the square of the selected piece.

9. The system according to claim 6, wherein the chess board displayed to at least one the two players is configured to identify that a square is occupied by a hidden piece.

10. A non-transient computer-readable memory storing computer program code which when run on a computer carries out the method of claim 1.
